(19) United States
(12) Patent Application Publication
(10) Pub. No.: US 2026/0002412 A1
(43) Pub. Date: Jan. 1, 2026

(54) CONTAINER AND ORGANIZATIONAL SYSTEMS

(71) Applicant: Werner Co., Itasca, IL (US)

(72) Inventors: Claire ARMENOFF, Montgomery, IL (US); David POZGAY, Wilmette, IL (US)

(21) Appl. No.: 18/881,164

(22) PCT Filed: Jul. 11, 2023
(86) PCT No.: PCT/US2023/027368

§ 371 Date: Jan. 3, 2025

Related U.S. Application Data
(60) Provisional application No. 63/388,059, filed on Jul. 11, 2022.

(51) Int. Cl. E06C 7/14; A45C 5/06; A45C 7/00; A45C 13/02; A45C 13/10; A45F 3/02; A45F 5/00

(52) U.S. Cl. CPC E06C 7/14; A45C 5/06; A45C 7/0036; A45C 13/103; A45F 3/02; A45F 5/1575; A45C 2013/026

(57) ABSTRACT

In some embodiments, containers, bags, and systems are provided that are useful to organize tools and other items. A tool bag may include a container body including one or more woven panels, a bottom rigid member, and a rigid wall hingedly connected to the bottom rigid member, and an engagement mechanism attached to the rigid wall. The engagement mechanism may include a base panel riveted on the rigid wall, and one or more protrusions extending from the base panel. In some aspects, the one or more protrusions are configured to engage with one or more holder slots on a ladder top.

### TECHNICAL FIELD

The present invention is generally related to a container or organizer for tools and/or other goods.

### BACKGROUND

Individuals such as carpenters, painters, electricians, and technicians often utilize ladders or other supporting structures when working. In addition, they also often appreciate relatively easy access to their tools and other small items while they are working. Holding and manipulating such tools and small items during a job or working from a ladder or other supporting structure can be inconvenient and may reduce an individual's efficiency. In addition, such individuals are often interested in having their items relatively organized so they can be located easily when needed.

### BRIEF DESCRIPTION OF THE DRAWINGS

The above needs are at least partially met through provision of the containers and organizational systems described in the following detailed description, particularly when studied in conjunction with the drawings, wherein:

FIG. 1 is a perspective view of a first side of a tool container in accordance with some embodiments.

FIG. 2 is a perspective view of a second side of the tool container in closed configuration showing places for external storage and carrying handles in accordance with some embodiments.

FIG. 3 is a perspective view of a portion of a stepladder in accordance with some embodiments.

FIGS. 4 and 4A illustrate a perspective and side view, respectively, of a tool container positioned above a ladder top before being attached to the ladder top in accordance with some embodiments.

FIGS. 5 and 5A illustrate a perspective and side view, respectively, of the tool container attached to a ladder top by means of its lugs engaged with the ladder top lug sockets in accordance with some embodiments.

FIGS. 6 and 6A illustrate one embodiment of an interior or internal portions of a tool container in accordance with some embodiments.

FIGS. 7 and 7A illustrate the internal panels of FIGS. 6 and 6A in a collapsed configuration in accordance with some embodiments.

FIG. 8 shows two rigid panels or portions attached to the outside of the tool container in accordance with some embodiments.

FIG. 9 is a cutaway view illustrating the relationship between the inner and outer panels and the container material in accordance with some embodiments.

FIG. 10 is a view illustrating the tool container when the container is in a collapsed configuration and the internal panels have been folded in accordance with some embodiments.

FIGS. 11A, 11B, and 11C show a container in a sequence beginning with the container wide open (FIG. 11A), the container being zipped shut (FIG. 11B), and the container being collapsed flat (FIG. 11C) in accordance with some embodiments.

FIG. 12 illustrates the tool container loaded with tolls in accordance with some embodiments.

FIG. 13 illustrates the tool container coupled to a ladder top in accordance with some embodiments.

FIG. 14 is a front perspective view of a tool bag in accordance with some embodiments.

FIG. 15 is a rear perspective view of aa tool bag in accordance with some embodiments.

FIG. 16 is a top perspective view of a bottom rigid member in accordance with some embodiments.

FIG. 17 is a bottom perspective view of a bottom rigid member in accordance with some embodiments.

FIG. 18 illustrates an engagement mechanism in accordance with some embodiments.

FIG. 19 is an exploded, partial view of a rear portion of a tool bag in accordance with some embodiments.

FIG. 20 is a detailed figure of portion FIG. 20A of FIG. 14.

FIG. 21 illustrates a tool bag in an open configuration in accordance with some embodiments.

FIG. 22 illustrates a tool bag in a collapsed or a partially collapsed configuration in accordance with some embodiments.

FIG. 23 illustrates a tool bag in an open configuration including a partition disposed therein in accordance with some embodiments.

FIG. 24 illustrates an organizational system in a detached or uncoupled configuration in accordance with some embodiments.

FIG. 25 illustrates an organizational system in an attached or coupled configuration in accordance with some embodiments.

FIG. 26 is a front top perspective view of a ladder top in accordance with some embodiments.

FIG. 27 is a top view of a ladder top in accordance with some embodiments.

FIG. 28 is a front view of a ladder top in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, containers, bags, device, apparatuses, systems, and methods are provided herein useful to organize tools and similar items for easy of access and transport. In some embodiments, a tool bag comprises a container body including one or more woven panels, a bottom rigid member, and a coupling or engagement mechanism. In one illustrative embodiment, the tool bag also includes a rigid wall hingedly connected to the bottom rigid member and the engagement mechanism attached to the rigid wall. In some configurations, the engagement mechanism includes a base panel riveted or otherwise secured to the rigid wall, and one or more protrusions extending from the base panel. In use, the one or more protrusions are configured to engage with one or more holder slots on a ladder top.

In some embodiments, containers, bags, and systems are provided that enable securely locking or coupling a container or bag relative to a ladder so that users do not need to hold the container or bag while they are working on the ladder or set it precariously atop a ladder. Containers and bags in accordance with some embodiments may be collapsible such that the containers and bags take up less volume while the containers and bags are not in use or while the containers and bags are being transported by users.

Accordingly, these teaching permit individuals utilizing a ladder to organize and easily carry and access their tools and other items while they are working. In addition to being easy to access when they are organized and disposed nearby, the tool bags and containers illustrated herein also are relatively lightweight and easy to transport and carry.

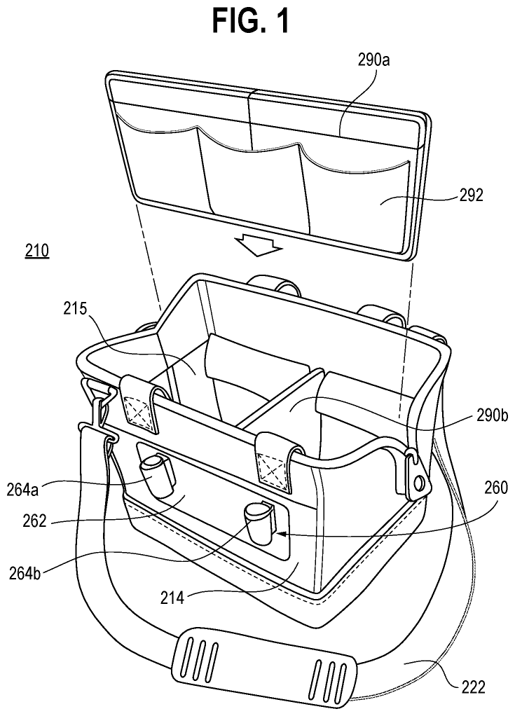

Referring now to the drawings wherein like reference numerals refer to similar or identical parts throughout the several views. More specifically, FIGS. 1-5A illustrate a ladder system 300 or portions thereof. The ladder system 300 includes a step ladder 310 having a front section 312 and a rear section 314 having at least one step 316 and having a ladder top 320. The ladder top 320 having a periphery and a front with a front facing edge and a rear in spaced relation to the front. The ladder top having at least a first slot 322a having an opening in the periphery disposed on the front facing edge. The first slot 322a is disposed at an edge of the top. The ladder system 300 also includes a container 210 for retaining and transporting items therein. The container 210 includes a rigid wall 214 with at least a first protrusion 264a which extends from the ridged wall 214. The first protrusion 264a engages with the first slot 322a to hold or couple the container 210 to the top 320. By some approaches, the container has at least a collapsible first wall 212 which forms a space or pocket 215 with the ridged wall. The container typically includes a strap and/or a handle 226. In use, when the first protrusion 264a securely engages with the first slot 322a of the ladder top 320, the weight of the container 210 may be largely supported by the first protrusion 264a in the first slot.

The front section 312 and the rear section 314 of the step ladder 310 each may have a plurality of rails. The plurality of rails of the front section 312 includes a right front rail. The right front rail is attached to an inside of a right flange of the ladder top 320. The right flange, as shown, is disposed between and attached to the front and the rear and extends down from the periphery. The plurality of rails of the rear section includes a rear right rail. The rear right rail, as shown, is attached to the inside of the right flange.

The shape of the first protrusion 264a typically corresponds with the shape of the first slot 322a to fit with the first slot 322a. In addition, the first slot 322a may be employed as a tool slot when the first protrusion 264a is not disposed in the first slot 322a. The ladder top 320 may have a second slot 322b having an opening in the periphery disposed at the front edge. The container may have a second protrusion 264b which fits in the second slot 322b. Each protrusion 264a, 264b may be disposed at a first side of the container 210 extending from the ridged wall 214. The first protrusion 264a may have an essentially cylindrical or conical shape.

In some embodiments, a method for working from a ladder includes the steps of filling a collapsible container with objects. In some approaches, the container has a rigid wall with at least a first protrusion which extends from the ridged wall. The container also may have at least a collapsible first wall which forms a pocket with the ridged wall when the first wall is open. The method also may include the step of engaging the at least the first protrusion with a first slot of a ladder top of the ladder to hold or couple the container to the ladder top. The ladder top having a periphery and a front with a front facing edge and a rear in spaced relation to the front. The ladder top typically having at least the first slot with an opening in the periphery disposed on the front facing edge. In this manner, the first slot is disposed at an edge of the top.

In some embodiments, a collapsible container is removably attachable to a ladder top via one or more slots. By some approaches the container comprises a rigid wall with at least a first protrusion which extends from the ridged wall. The first protrusion is engageable with the first slot of the ladder top to hold the container to the top. The container includes at least a collapsible first wall which forms a pocket with the ridged wall when the collapsible first wall is open. The container also may include a handle attached adjacent to the first wall, and the weight of the container may be at least partially supported by the first protrusion being disposed in the first slot.

In some embodiments, a support system includes a support structure having at least a first lug socket. By some approaches, the container has a rigid wall with at least a first protrusion which extends from the ridged wall. The first protrusion engages with the first slot to hold the container to the support structure. The container may have at least a collapsible first wall which forms a pocket with the ridged wall is open, the container has a handle, the weight of the container supported by the first protrusion in the first slot.

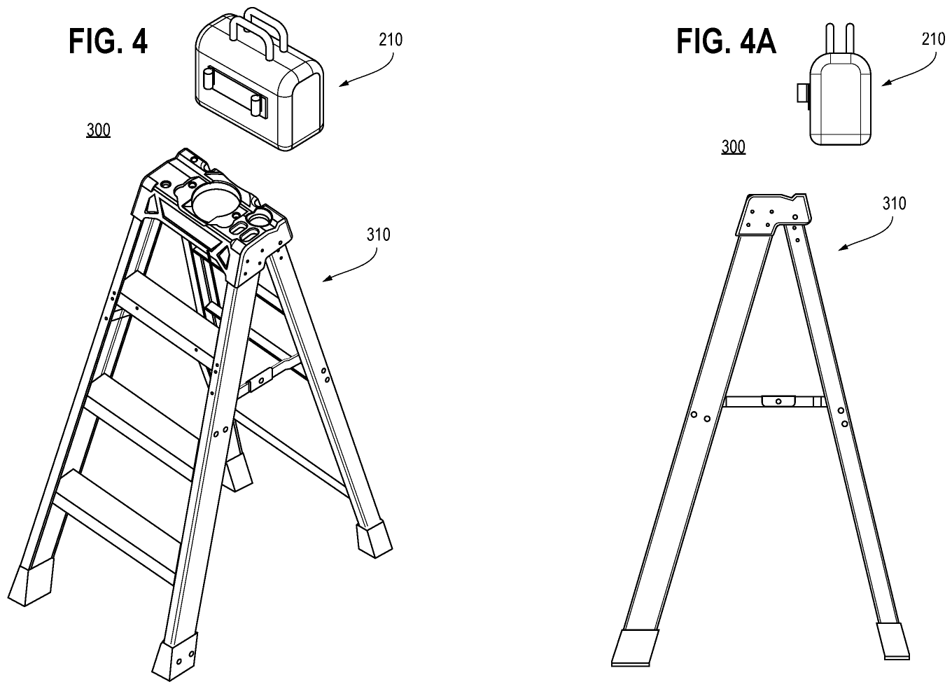

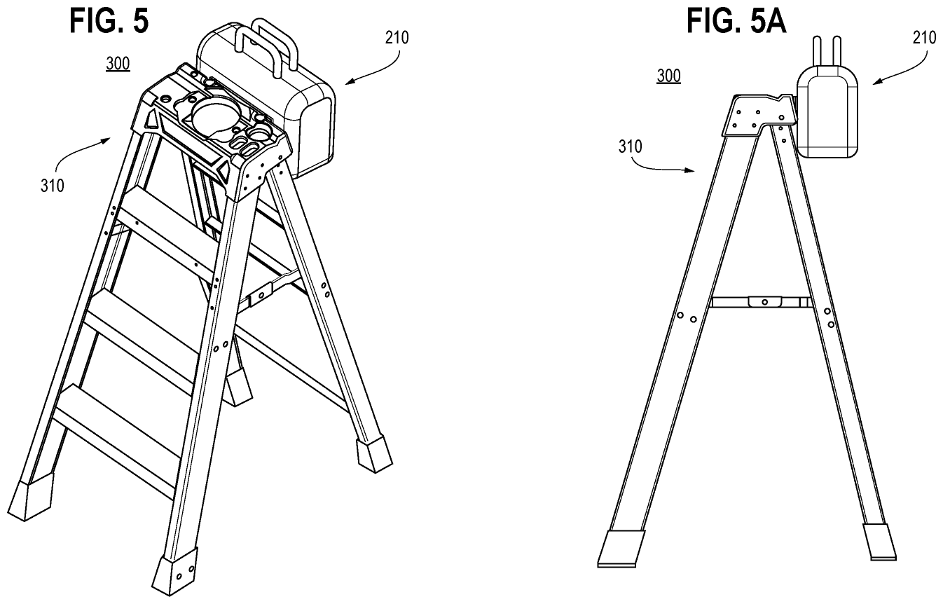

In some aspects, a collapsible tool container is removably attachable to a ladder top with a first slot, as shown in FIGS. 4 and 5. The method may include the steps of attaching a protrusion panel 260 to an inner back panel 276 made of ridged material and engaging the inner back panel 276 with an inner bottom panel 204a made of rigid material. The method also may include attaching flexible straps 284 to the inner back panel 276 and to the inner bottom panel 204a to maintain a right angle relationship between the inner back panel 276 and inner bottom panel 204a when the tool container is in an open position.

In some embodiments, a collapsible tool container 210 has rigid lugs 264a, 264b which permit the tool container 210 to be attached or coupled to the accessory sockets or opening slots of a ladder top or to the accessory sockets of other products such as scaffolds or utility carts, etc. The tool container 210 can be closed by a zipper 206 or Velcro or buttons or snaps and has a handle 226 for easy transport when not attached to a ladder top. The tool container 210 may include a flexible material, a semi-rigid material, and/or a rigid material.

In some embodiments, the tool container 210 has one or more internal supports or rigid panels. For example, the tool container 210 includes internal rigid panels 276, 204a which maintain the tool container 210 in a box-like form even when it is hanging by its lugs 264a, 264b. These panels 276, 204a can also fold together or relative to one another, which permits the tool container to be collapsed when empty.

By some approaches, the user can fill the tool container 210 with various tools and supplies one anticipates needing for a given job, then carry the tool container to the jobsite. The tool container 210 can then be conveniently attached to the ladder top 320, etc., to provide quick access to the tools and supplies while the user is standing on the ladder, scaffold, or working from a utility cart. Even if not needed for use while attached to another product, this tool container 210 is a convenient way to carry tools and supplies.

FIG. 1 illustrates a tool container 210 which has rigid lugs 264a, 264b on the side. The tool container 210 may have a carrying strap 222, internal removeable partitions 290a, 290b, pockets 292 for holding small items, and carrying handles 226, among other features.

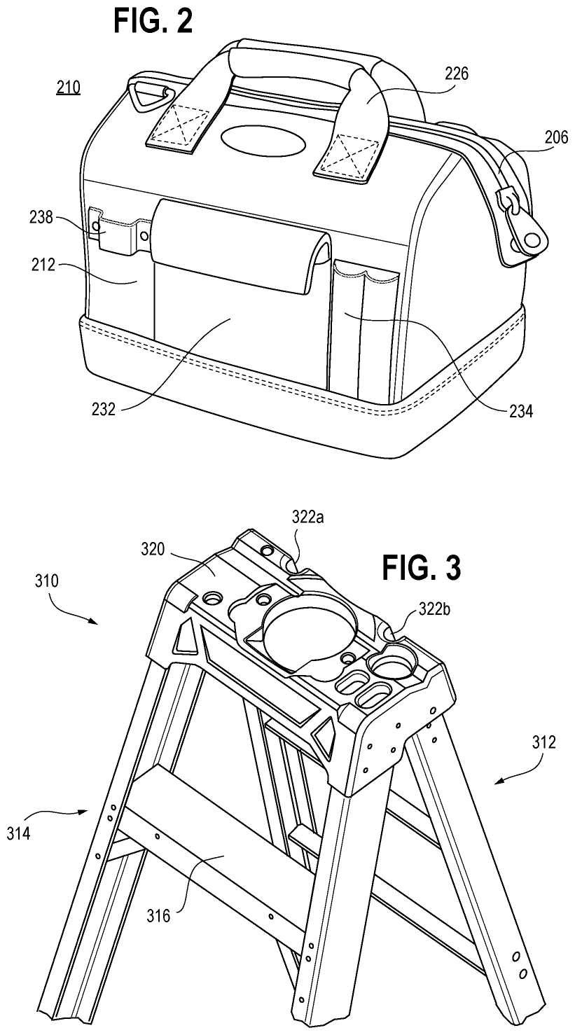

FIG. 2 illustrates a view of the closed tool container 210 showing external storage 232, 234, 238 and carrying handles 226. A zipper closure 206 is shown but other methods may be used.

FIG. 3 shows the top of a step ladder having lug sockets 322a, 322b for attaching accessories. Note that other products such as scaffolds, utility carts, work platforms, and pump jacks may be equipped with lug sockets to which the tool container may be attached.

FIGS. 4 and 4A show a perspective and side view, respectively, of a tool container 210 positioned prior to coupling with a ladder top 320.

FIGS. 5 and 5A show a perspective and side view, respectively, of the tool container 210 coupled or attached to a ladder top by means of its lugs engaged with the ladder top lug sockets 322a, 322b.

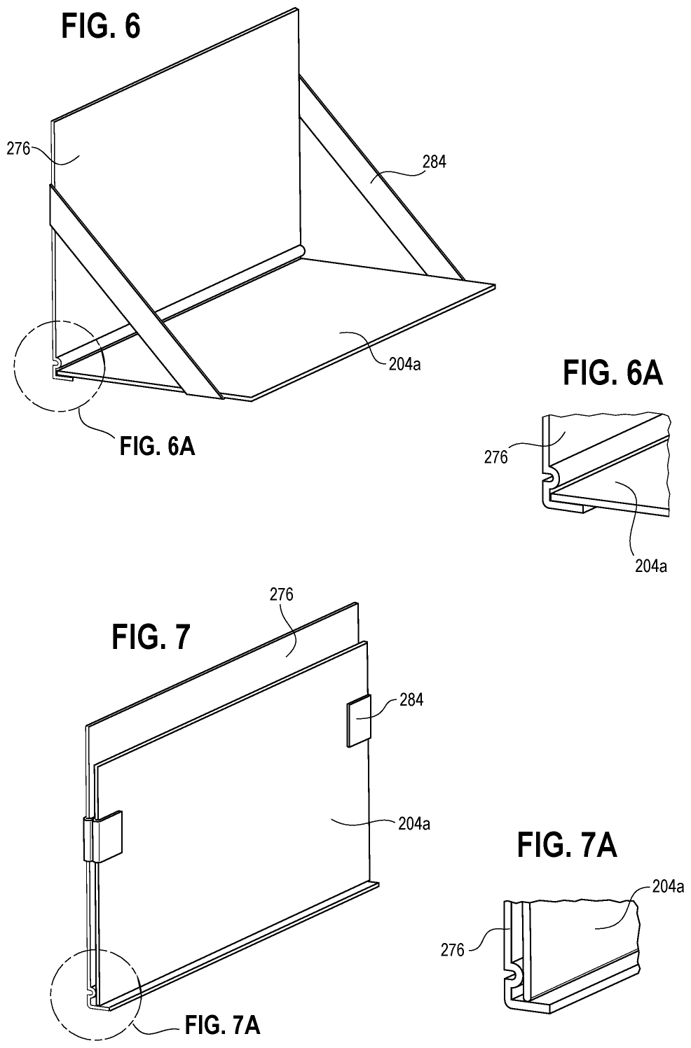

FIG. 6 and FIG. 6A show partial, internal construction details of the tool container. The inner back panel 276 and inner bottom panel 204a are made of semi-rigid or rigid material such as molded plastic. The two panels 276, 204a engage each other as shown in FIG. 6A. Flexible straps 284 may attached to the panels maintain a right angle relationship between the panels 276, 204a when the tool container 210 is not deliberately collapsed. In this manner, the panels may be retained in substantially a right angle relationship such that the tool container 210 has a box-like form and is accessible when containing tools and hanging from its lugs.

FIG. 7 and FIG. 7A show the relationship between the inner panels 276, 204a when the tool container 210 has been collapsed. In some embodiments, the flexible straps 284 have folded up in between the inner panels 276, 204a.

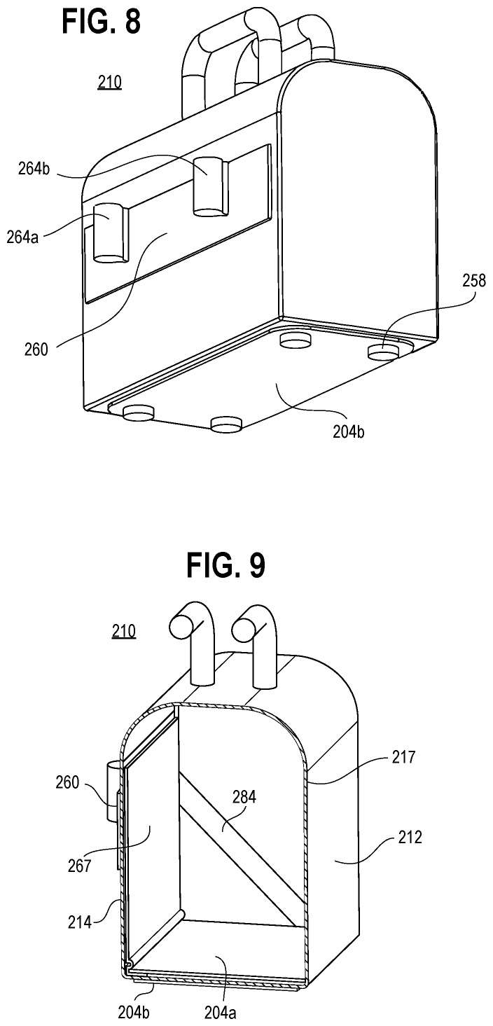

FIG. 8 shows two rigid panels 262, 204b attached to the outside of the tool container 210. The outer lug panel 260, which may be formed of a molded plastic, includes one or more lugs. The outer base panel 204b, also possibly of a molded plastic material, has feet 258 on which the tool container may rest when not attached to a ladder, etc.

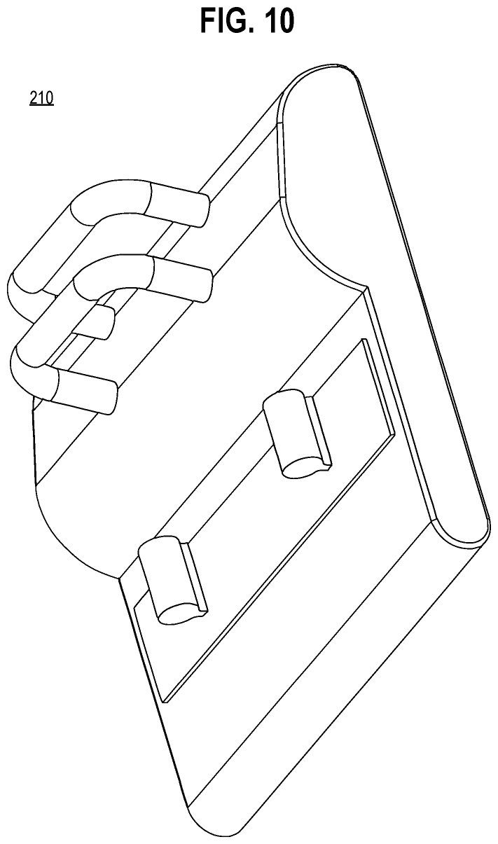

FIG. 9 is a cutaway view of a portion of a tool bag showing the relationship between the inner and outer panels and the container material. The container material 217 may be a fabric such as a woven fabric material or some other substantially flexible material which will allow the tool container 210 to be collapsed when empty. The container material 217 is typically sandwiched between the lug panel 260 and inner back panel 267, and sandwiched between the outer base panel 204b and the inner bottom panel 204a. The rigid panels and container material may be held together by rivets and/or stitching or other means common to manufacturers of duffle bags, etc.

FIG. 10 is a view showing the tool container 210 when the container 210 is collapsed such that the inner panels 276, 204a have been folded toward one another. The portion of the tool container where the handles attach may be further collapsed if they are formed of a flexible material.

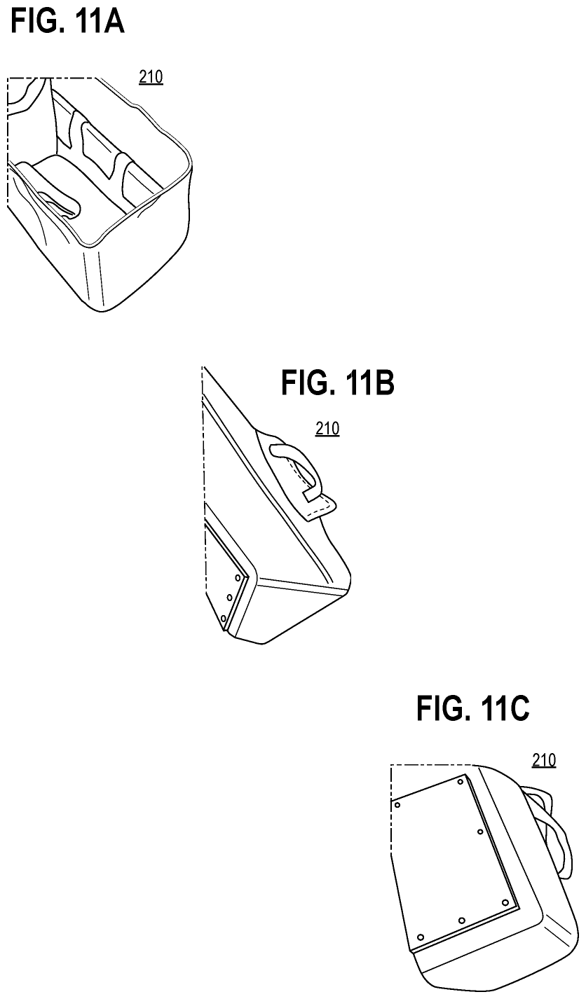

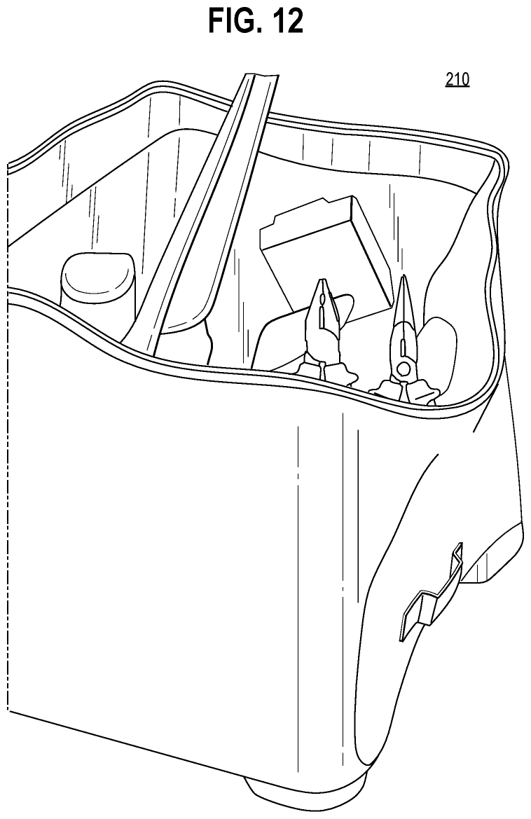

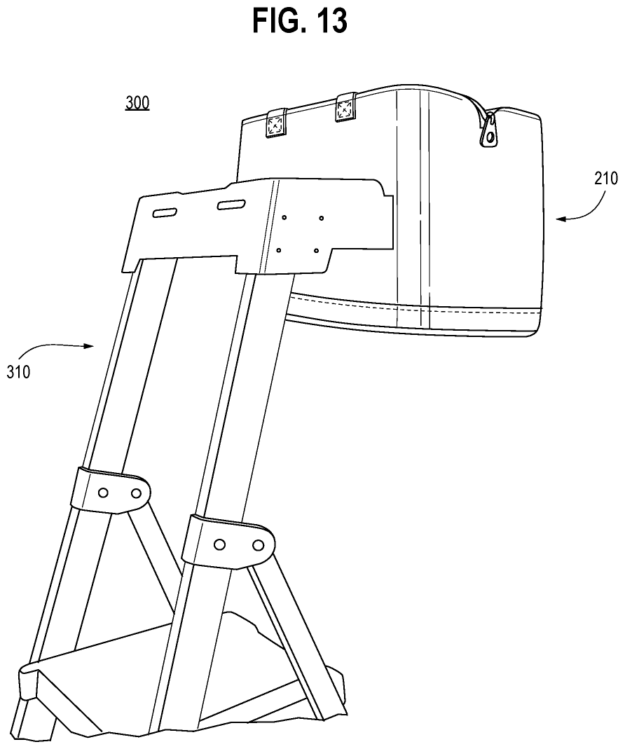

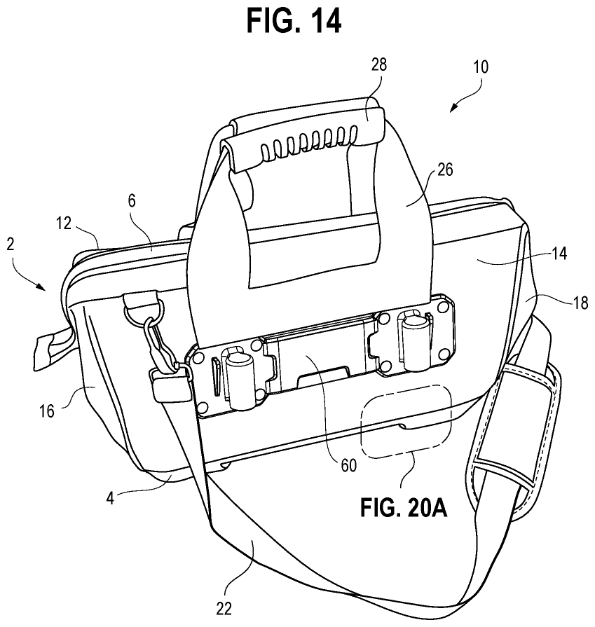

FIGS. 11A, 11B and 11C show a container in a sequence beginning with the container wide open-FIG. 11A, the container is zipped shut-FIG. 11B, the container is collapsed flat-FIG. 11C.

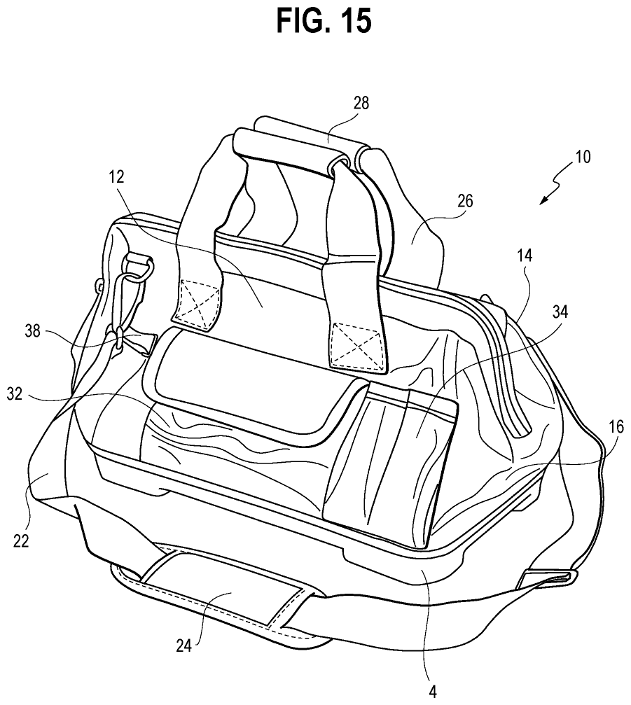

FIGS. 12 and 13 show the tool container loaded with tools and attached to a ladder top.

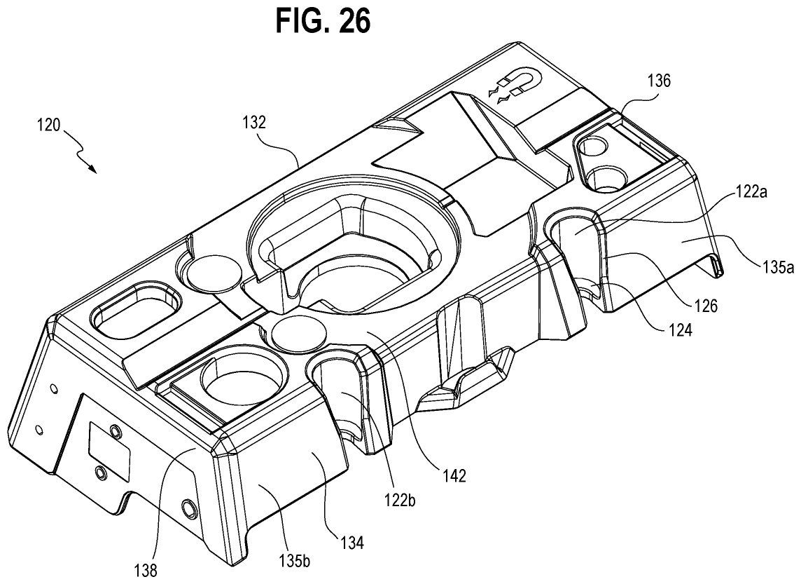

Turning to FIGS. 14-28, other embodiments of a tool bag 10 and an organizational system 100 are illustrated. For conciseness and clarity, the reference numerals used for features of the tool container 210 of the prior embodiments discussed above that correspond to similar features of the tool bag 10 of FIGS. 14-28 will be used without a prefix “2.” For example, a feature of the tool container 210 referenced by the reference numeral “214” will be shown with reference numeral “14” with regard to the tool bag 10. Similarly, the reference numerals used for features of the system 300 of prior embodiments discussed above that correspond to similar features of the system 100 of FIGS. 25-28 will be used with a prefix “1” instead of the prefix “3.” For example, a feature of the system 300 referenced by the reference numeral “310” will be shown with reference numeral “110” with regard to the system 100. Any features of the tool container 210 and/or the system 300 may be incorporated into the tool bag 10 and/or the system 100 in a manner similar to that described with the prior embodiments. Further, any features of the tool bag 10 and the system 100 may be incorporated into the tool container 210 and/or the system 300.

FIG. 14 is a front perspective view of a tool bag 10 in accordance with some embodiments. FIG. 15 is a rear perspective view of the tool bag 10 in accordance with some embodiments. The tool bag 10 may be a collapsible container bag. As shown in FIG. 14, the tool bag 10 includes a container body 2 and an engagement mechanism 60 attached to the container body 2.

In some aspects, the container body 2 includes one or more flexible or woven panels 12, 16, 18, and a bottom rigid member 4, and a rigid wall 14 hingedly connected to the bottom rigid member 4. The one or more woven panels 12, 16, 18 may include a front woven panel 12, a first side woven panel 16, and a second side woven panel 18. The one or more woven panels 12, 16, 18 may be collapsible. For example, all the front woven panel 12, the first side woven panel 16, and the second side woven panel 18 are collapsible.

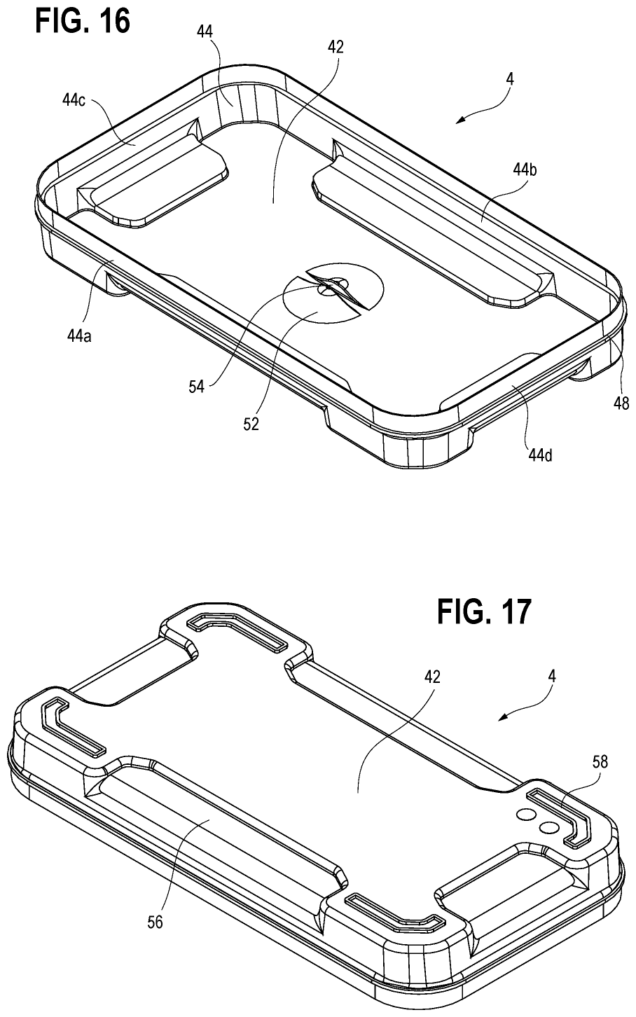

FIG. 16 is a top perspective view of the bottom rigid member 4, and FIG. 17 is a bottom perspective view of the bottom rigid member 4. In some embodiments, the bottom rigid member 4 includes a bottom plate 42 and a lip 44 extending around a perimeter of the bottom plate 42. The lip 44 may have a front lip 44a, a rear lip 44b opposite the front lip 44a, a first side lip 44c, and a second side lip 44d opposite the first side lip 44c. In some aspects, the bottom plate 42 may have a generally rectangular shape with curved or arcuate corners. In some embodiments, the shape of the bottom plate 42 may be a rounded edge rectangle. The lip 44 may vertically extend from the edges of the bottom plate 42. The front lip 44a may extend from the front edge of the bottom plate 42, a rear lip 44b may extend from the rear edge of the bottom plate 42, a first side lip 44c may extend from a first side edge of the bottom plate 42, and a second side lip 44d may extend from the second side edge of the bottom plate 42. The corners of the lip 44 may be rounded such that the boundaries between the front lip 44a, the rear lip 44b, the first side lip 44c, and the second side lip 44d may be curved. In some embodiments, the lip 44 may have a ridge 48 along the outer surface of the lip 44.

In some embodiments, the front woven panel 12, the first side woven panel 16, and the second side woven panel 18 are connected to the front lip 44a, the first side lip 44c, and the second side lip 44d, respectively. The front woven panel 12 may be hingedly connected to the front lip 44a of the bottom rigid member 4. The rigid wall 14 may be hingedly connected to the rear lip 44b of the bottom rigid member 4.

In some embodiments, each of the four edges of the bottom rigid member 4 may include a recess 56 at or near the middle portion of each edge, which may facilitate balancing the tool bag 10 when the tool bag 10 rests on a floor or a shelf. In some embodiments, the bottom plate 42 has feet 58 near four corners of the lower surface of the bottom plate 42 on which the tool bag 10 may rest when put on a floor or a shelf.

In some embodiments, the upper surface of the bottom plate 42 may include a ridge 52. The ridge 52 may be disposed at the center of the upper surface of the bottom plate 42. In some embodiments, the ridge 52 has a slot 54 across the ridge 52. As discussed later, referring to FIG. 23, the slot 54 of the ridge 52 may be used to secure or fix the position of a partition 90 when the partition 90 is inserted into the inside of the tool bag 10.

In some embodiments, the bottom rigid member 4 may be made of rigid material such as, e.g., of molded plastic. In some embodiments, the bottom rigid member 4 may include copolymer polypropylene and polyethylene. In some aspects, the bottom rigid member 4 may be made of plastic including 30% to 90% copolymer polypropylene and 10% to 70% polyethylene. In some aspects, the bottom rigid member 4 may be made of plastic including 50% to 70% copolymer polypropylene and 30% to 50% polyethylene. In some aspects, the bottom rigid member 4 may be made of plastic including 55% to 65% copolymer polypropylene and 35% to 45% polyethylene. In one aspect, the bottom rigid member 4 may be made of plastic including 60% copolymer polypropylene and 40% polyethylene.

Referring back to FIGS. 14-15, the tool bag 10 may include one or more fasteners 6 that can be used to close the tool bag 10. The fastener 6 illustrated in FIG. 14 is a zipper and may be configured to bind a top end of the rigid wall 14 and a top end of the front woven panel 12 in a closed configuration of the tool bag 10. In addition to a zipper, the fastener 6 may include a Velcro (hook-and-loop fastener), buttons, and/or snaps, and or a combination thereof. In some embodiments, the fastener 6 may extend to the first and second side woven panels 16, 18. In the closed configuration, each top end of the first and second side woven panels may be folded and bound by the fastener when the tool bag 10 is in the closed configuration.

In some embodiments, the tool bag 10 may further include a handle 26. A user may use the handle 26 when transporting the tool bag 10. In some aspects, the handle 26 may include a rigid grip 28 to facilitate gripping and holding the tool bag 10. The rigid grip 28 may have multiple ribs (ribbing) to prevent the rigid grip from getting out of the user's hand while the tool bag is being held.

In some embodiments, the tool bag 10 may further include a shoulder strap 22. A user may use the shoulder strap 22 when transporting the tool bag 10. By using the shoulder strap 22, the user may keep their hands free to grab the ladder while climbing a ladder or other supporting structure. In some embodiments, the shoulder strap 22 may include a shoulder cushion 24.

In some embodiments, the front woven panel 12 may include one or more external storage element 32, 34, 38 on the outer surface thereof. The external storage element(s) may include one or more pockets 34, 38. In some aspects, the external storage may include one or more brackets 38 for hanging tools or items.

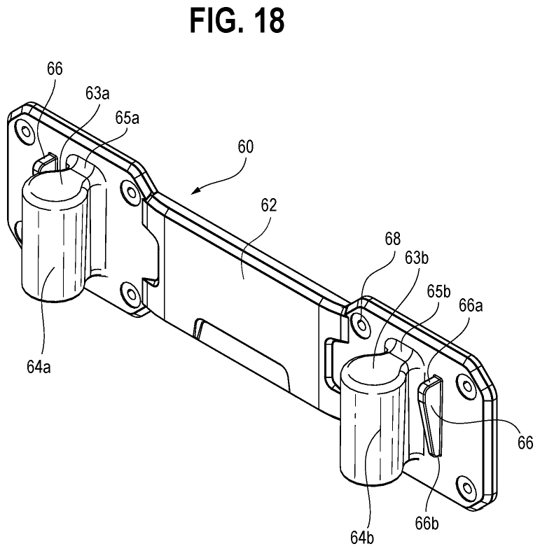

FIG. 18 illustrates the engagement mechanism 60 in accordance with some embodiments. The engagement mechanism 60 may be attached to the rigid wall 14. For example, the engagement mechanism 60 may be attached to the rigid wall with one or more rivets. In some embodiments, the engagement mechanism 60 includes a base panel 62 and one or more protrusions 64a, 64b extending from the base panel 62. The one or more protrusions 64a, 64b are configured to engage with one or more retention or holder slots 122a, 122b on a ladder top 120 (see FIG. 25) or other support structures.

In some aspects, the one or more protrusions 64a, 64b include a cylindrical member 63a, 63b and an extending, connecting member 65a, 65b. The extending, connecting member 65a, 65b extends from the base panel 62 and connects the cylindrical member 63a, 63b to the base panel 62 and is typically a pinched or narrow section therebetween. The cylindrical member 63a, 63b may extend along a side of the tool bag, for example, along the surface of the rigid wall 14.

In some aspects, the width of the extending member 65a, 65b may be narrower than the width of the cylindrical member 63a, 63b. The narrower width of the extending member 65a, 65b may facilitate the engagement of the one or more protrusions 64a, 64b with the retention or holder slots 122a, 122b on a ladder top 120 and allow the tool bag 10 to be more securely coupled to the ladder top 120.

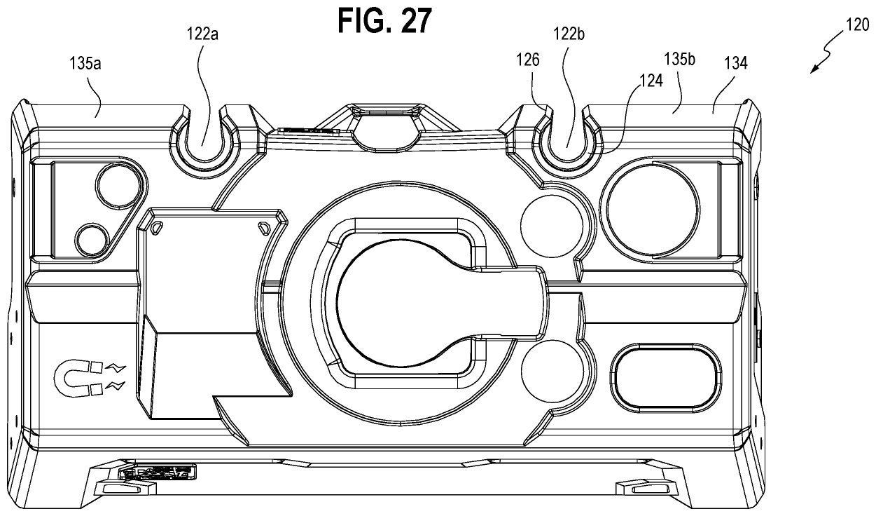

In some embodiments, the engagement mechanism 60 further includes one or more ribs 66 extending from the base panel 62. The one or more ribs 66 are configured to abut or rest against one or more angled surfaces 135a, 135b of the ladder top 120 when the engagement mechanism 60 is coupled to the one or more holder slots 122a, 122b of the ladder top 120 (see FIG. 26). The one or more ribs 66 resting against the one or more angled surfaces 135a, 135b of the ladder top 120 may distribute the weight of the tool bag 10 supported by the one or more protrusions 64a, 64b. The front end of the one or more ribs 66 may be in contact with and in alignment with the one or more angled surfaces 135a, 135b of the ladder top 120 when the engagement mechanism 60 is coupled to the one or more holder slots 122a, 122b on the ladder top 120. In some aspects, the extending length of a top end 66a of the one or more ribs 66 is greater than an extending length of a bottom end 66b of the one or more ribs 66. The extending length of the one or more ribs 66 may be continuously reduced from the top end 66a to the bottom end 66b along the angle of the one or more angled surfaces 135a, 135b of the ladder top 120.

In some embodiments, the engagement mechanism 60 is made of rigid, solid material. For example, the engagement mechanism 60 may include copolymer polypropylene. In some aspects, the engagement mechanism 60 may be made of molded copolymer polypropylene. In one aspect, the engagement mechanism 60 may be made of 100% copolymer polypropylene. For example, the engagement mechanism 60 may be made of polypropylene K7926.

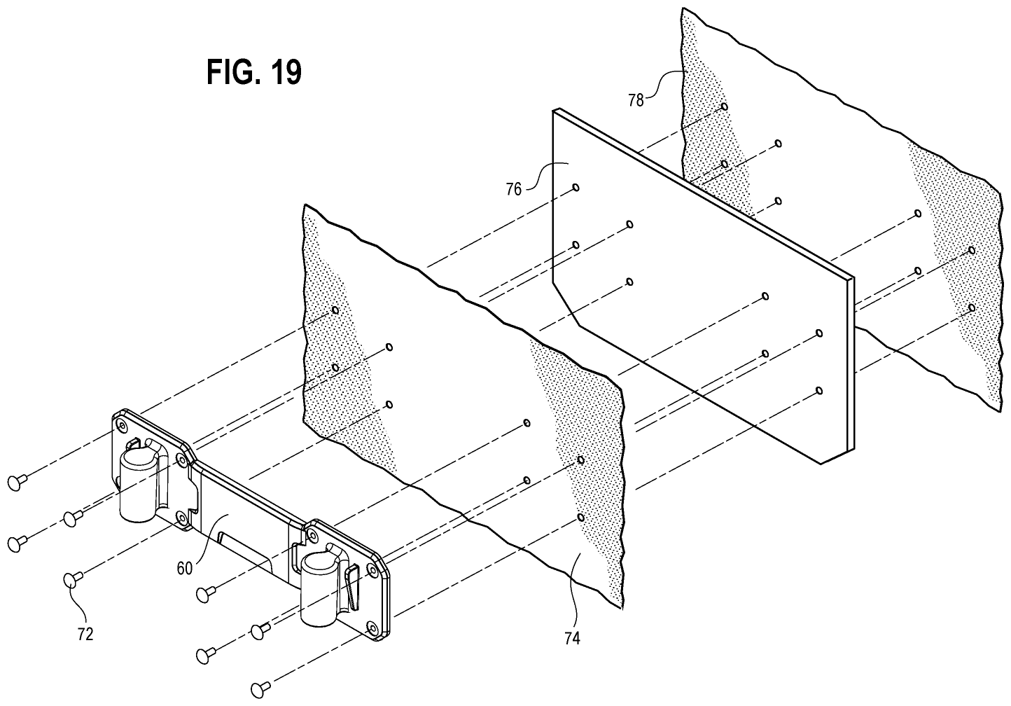

FIG. 19 is an exploded, partial view of the rear portion of the tool bag 10 illustrating the rigid wall 14 and the engagement mechanism 60 attached to the rigid wall 14 in accordance with some embodiments. Referring to FIG. 19, in some embodiments, the rigid wall 14 may include an interior strengthening, anchoring or securement panel 76 and a fabric portion 74, 78 encompassing the interior securement panel 76. The fabric portions 74, 78 may include an exterior or outer fabric sheet 74 and an interior or inner fabric sheet 78, such as a bag lining. The interior securement panel 76 may be disposed between the outer fabric sheet 74 and the inner fabric sheet 78. The engagement mechanism 60, the outer fabric sheet 74, the interior securement panel 76, and the inner fabric sheet 78 may be secured relative to one another or held together by rivets 72, stitching, adhesives, other means, and/or a combination thereof. In some embodiments, the engagement mechanism 60 may be attached to the rigid wall 14 with one or more rivets 72 penetrating the rigid wall 14. The one or more rivets 72 may penetrate the engagement mechanism 60, the outer fabric sheet 74, the interior enhancing panel 76, and the inner fabric sheet 78.

In some embodiments, the interior securement panel 76 may have a generally rectangular shape. For example, the shape of the interior securement panel 76 may be a rectangle with cut lower edges. In some embodiments, the interior securement panel 76 may be made of rigid material. In some embodiments, the interior securement panel 76 is made of rigid, solid material. For example, the interior securement panel 76 may include copolymer polypropylene. In some aspects, the interior securement panel 76 may be made of molded copolymer polypropylene. In one aspect, the interior securement panel 76 may be made of 100% copolymer polypropylene.

In some embodiments, each of the one or more woven panels 12, 16, 18 may include the outer fabric sheet 74 and the inner fabric sheet 78. The outer fabric sheet 74 and the inner fabric sheet 78 may overlap.

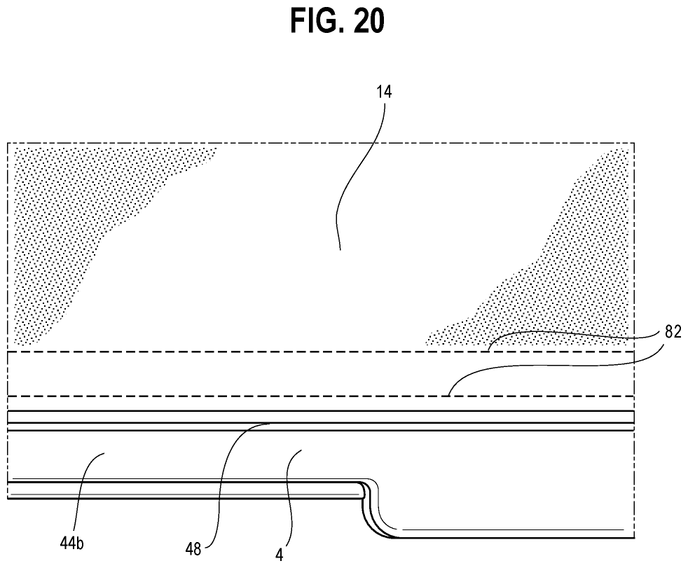

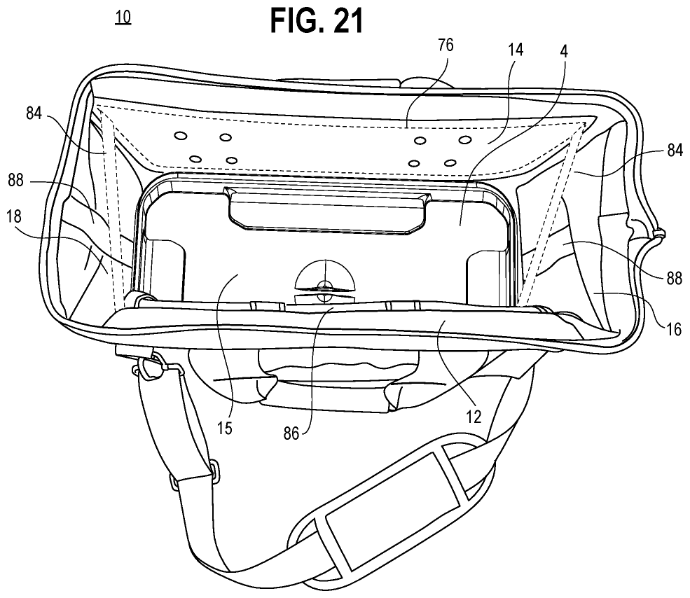

FIG. 20 is a detailed figure of portion FIG. 20A of FIG. 14 illustrating the connection between the rigid wall 14 and the bottom rigid member 4. The rigid wall 14 may be hingedly connected to the rear lip 44b of the bottom rigid member 4 via a seam including stitching 82 fixing the rigid wall 14 to the rear lip 44b of the bottom rigid member 4. When the seam includes two or more lines of stitching 82, the uppermost stitching line may function as a hinge.

Similarly, in some embodiments, the front woven panel 12 may be hingedly connected to front lip 44a of the bottom rigid member 4 via a seam including stitching 82 fixing the front woven panel 12 to the front lip 44a of the bottom rigid member 4. In some embodiments, the first side woven panel 16 and the second side woven panel 18, respectively, may be hingedly connected to the first side lip 44c and the second side lip 44d via a seam including one or more stitching 82 fixing the first and second side woven panels 16, 18 to the first and second side lips 44c, 44d respectively. In some embodiments, one or more adhesive elements also may be employed.

In some embodiments, the stitching 82 may be formed at the upper portion of the lip 44 which is above the ridge 48 disposed along the outer surface of the lip 44. For example, the stitching 82 may penetrate the outer fabric sheet 74, the upper portion of the lip 44, and the inner fabric sheet 78. In some embodiments, the stitching may be formed with a needle that may penetrate the outer fabric sheet 74, the upper portion of the lip 44, and the inner fabric sheet 78. In some embodiments, the stitching holes are formed while the stitching needle penetrates the outer fabric sheet 74, the upper portion of the lip 44, and the inner fabric sheet 78 to form the stitching 82. The stitching needle may be hard enough to form stitching holes on the upper portion of the lip 44 of the bottom rigid member 4.

In some embodiments, the stitching 82 does not penetrate the interior securement panel 76 when fixing the rigid wall 14 to the bottom rigid member 4 such that the collapsible feature of the inner and outer fabric sheets 74, 78 allow the rigid wall 14 to be tilted relative to the bottom plate 42 of the bottom rigid member 4 by rotating around the upmost stitching line.

FIG. 21 illustrates a tool bag 10 in an open configuration in accordance with some embodiments. In some embodiments, the tool bag 10 may further include one or more flexible straps 84 attached to the bottom rigid member 4 and the interior enhancing, securement panel 76. One end of the flexible strap 84 may be attached to the side end of the interior enhancing, securement panel 76 and the other end of the flexible strap 84 may be attached to the first side lip 44c or the second side lip 44d of the bottom rigid member 4. In some embodiments, the tool bag 10 may include two flexible straps 84. The first flexible strap may be attached to the first side lip 44c of the bottom rigid member 4 and the corresponding side end of the interior securement panel 76. The second flexible strap may be attached to the second side lip 44d of the bottom rigid member 4 and the corresponding side end of the interior securement panel 76.

In some embodiments, the one or more flexible straps 84 may define a maximum angle between the interior enhancing panel 76 and the bottom plate 42 of the bottom rigid member 4. In some embodiments the one or more flexible straps 84 may define a maximum angle between the rigid wall 14 and the bottom plate 42 of the bottom rigid member 4.

In some embodiments, the angle between the interior securement panel 76 (or the rigid wall 14) and the bottom plate 42 may be maximum when the flexible straps 84 is fully extended. In some embodiments, when the flexible straps 84 is fully extended, the angle between the interior securement panel 76 (or the rigid wall 14) and the bottom plate 42 of the bottom rigid member 4 may be about 90 degrees and the tool bag 10 may be in a box-like shape.

In some embodiments, the one or more flexible straps 84 may be disposed between the outer fabric sheet 74 and the inner fabric sheet 78 such that the one or more flexible straps 84 may not be shown from the inside (e.g., the container space) or outside of the tool bag 10.

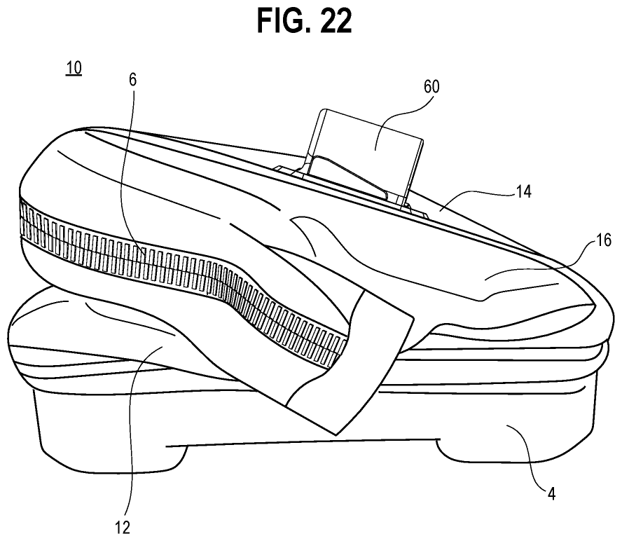

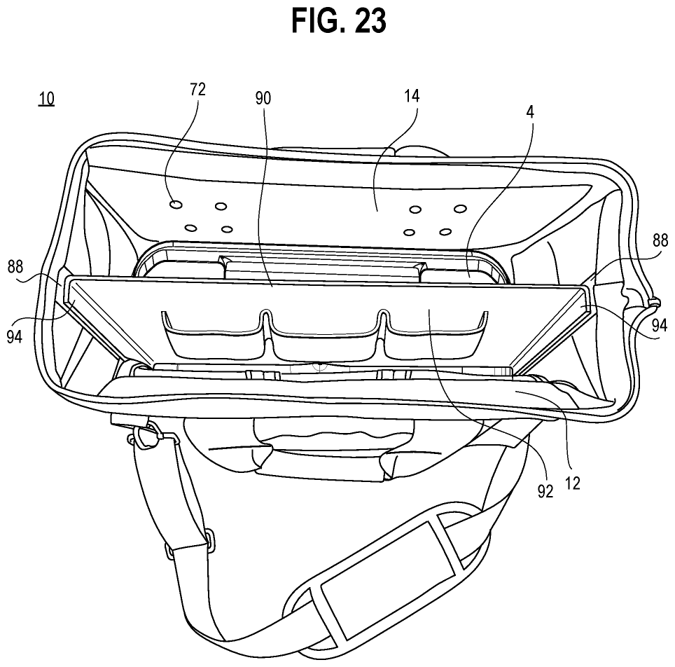

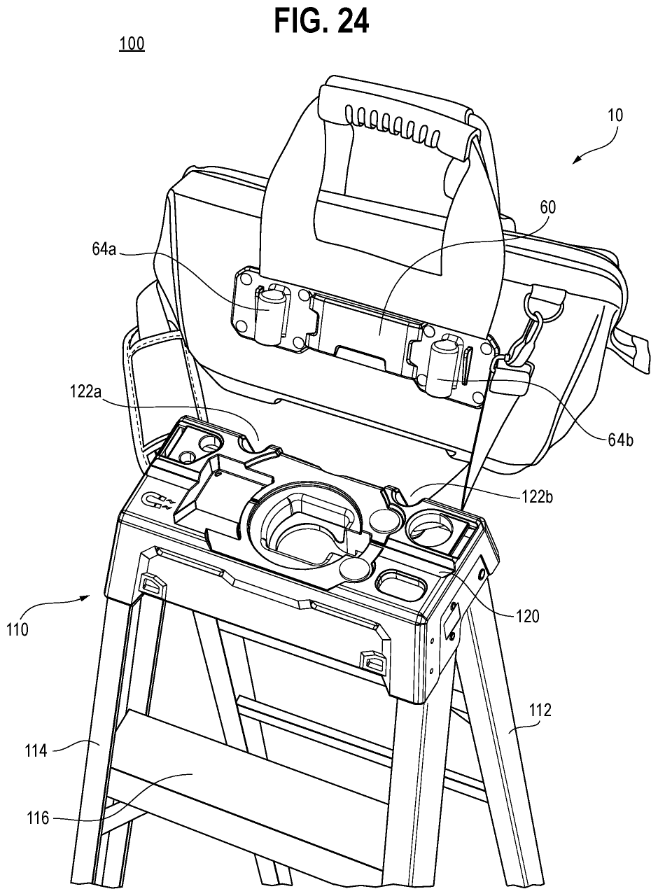

FIG. 22 illustrates the tool bag 10 in a collapsed configuration. When the tool container 10 has been collapsed, the flexible straps 84 may be folded inward toward or around the collapsed shape of the first and second side woven panels 16, 18.

In some embodiments, the front woven panel 12 may be horizontally collapsible. For example, the front woven panel 12 may be collapsed along a collapsing line horizontally crossing the front woven panel 12.

In some embodiments, the front woven panel 12 may include a guide panel or support panel (not shown) disposed between the outer and inner fabric sheets 74, 78 of the front woven panel 12. In some embodiments, the front woven panel 12 may collapse along an edge of the guide panel or support panel. In some aspects, the guide panel or support panel may be positioned between the hinged edge connecting the front woven panel 12 to the front lip 44a of the bottom rigid member 4 and the collapsing line of the front woven panel 12. The collapsing line of the front woven panel 12 may be at or adjacent to the middle height of the front woven panel 12. The guide panel may have a generally rectangular shape. In some embodiments, the guide panel may be made of rigid or semi-rigid material. In some embodiments, the guide panel may be made of plastic including copolymer polypropylene and polyethylene. In some aspects, the guide panel or support panel may be made of plastic including 30% to 90% copolymer polypropylene and 10% to 70% polyethylene. In some aspects, the bottom rigid member 4 may be made of plastic including 50% to 70% copolymer polypropylene and 30% to 50% polyethylene. In some aspects, the bottom rigid member 4 may be made of plastic including 55% to 65% copolymer polypropylene and 35% to 45% polyethylene. In one aspect, the bottom rigid member 4 may be made of plastic including 60% copolymer polypropylene and 40% polyethylene.

FIG. 23 illustrates the tool bag 10 in an open configuration with a partition 90 in accordance with some embodiments. In some embodiments, the tool bag 10 may further include a partition 90 removably attachable to the inside of the tool bag 10. In some embodiments, the partition 90 may be attached to the inside of the tool bag 10 with one or more fasteners. In some aspects, the fastener may be a hook-and-loop fastener and/or snaps. In one illustrative example, loop straps 88 may be disposed on an inside surface of the first and second side woven panels 16, 18 or lining and hooks straps 94 may be at the ends of the partition 90. The partition 90 may be removably attached to the tool bag 10 with the hook-and-loop fastener 88, 94. In some embodiments, when the partition 90 is inserted into the tool bag, the bottom end of the partition 90 may be inserted into the slot 54 of the ridge 52 of the bottom plate 42 (see FIG. 16) such that the position of the partition 90 may be relatively fixed into position. The partition 90 may divide the containing space of the tool bag 10. In some embodiments, the partition 90 may include one or more pockets 92 facilitating organizing tools or items.

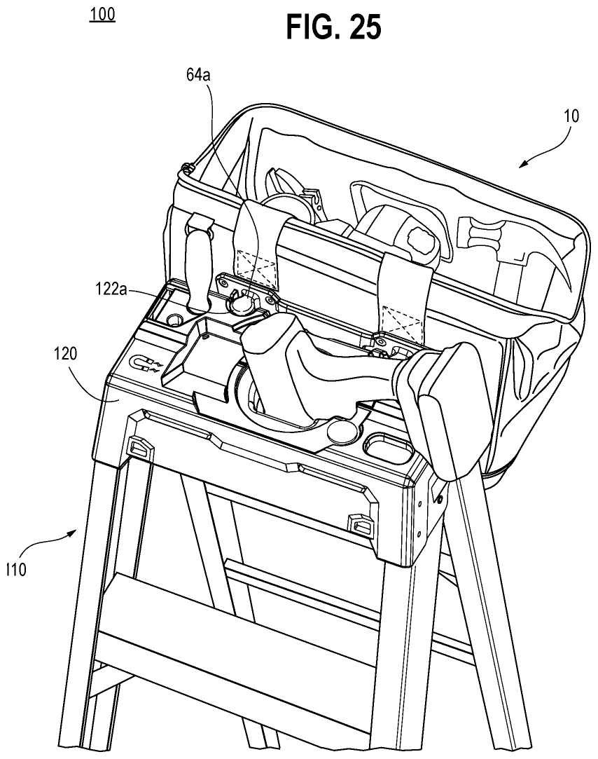

FIG. 24 illustrates an organizational system 100 in a detached configuration in accordance with some embodiments, and FIG. 25 illustrates the organizational system 100 in an attached or coupled configuration in accordance with some embodiments. As shown, the organizational system 100 includes a ladder 110 and a tool bag 10. The tool bag 10 of the organizational system 100 may be the tool bag 10 of FIGS. 14-23. In some embodiments, the ladder 110 has a front section 112, a rear section 114 having at least one step 116, and a ladder top 120 having one or more holder slots 122a, 122b. The tool bag 10 may be removably fixed/attached to the ladder top 120 with the engagement mechanism 60.

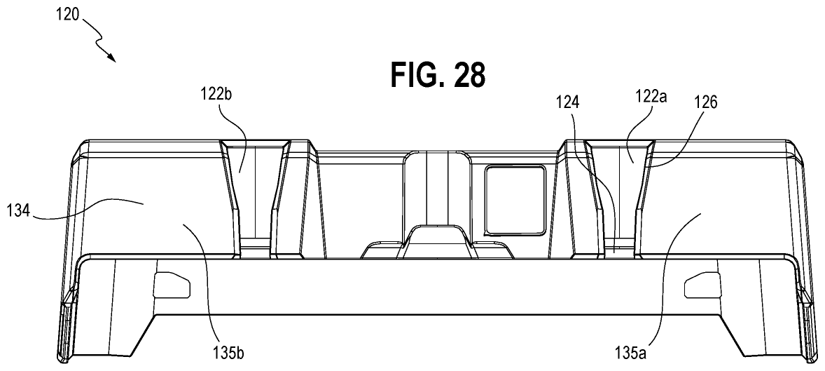

FIG. 26 is a front top perspective view of the ladder top in accordance with some embodiments. FIG. 27 is a top view of the ladder top in accordance with some embodiments. FIG. 28 is a front view of the ladder top in accordance with some embodiments.

In some embodiments, the one or more retention or holder slots may have a generally cylindrical shape corresponding to the shape of the cylindrical member 63a, 63b of the engagement mechanism 60. In some configurations, a portion of the slot 122a, 122b a walls that angled inward giving that portion of the slot 122a, 122b a slightly inverted, truncated cone shape. In addition, the lower portion of the slot 122a, 122b may have a ledge 124 extending inward as described below.

In some embodiments, the one or more holder slots 122a, 122b may open to top, bottom, and front side of the ladder top 120. When the one or more protrusions 64a, 64b are inserted into the one or more holder slots 122a, 122b to engage with the one or more holder slots 122a, 122b, the one or more cylindrical member 63a, 63b of the one or more protrusion 64a, 64b may be inserted through the one or more top openings of the one or more holder slots 122a, 122b. While the one or more cylindrical member 63a, 63b of the one or more protrusion 64a, 64b move down through the one or more top openings of the one or more holder slots 122a, 122b, the extending, connecting member 65a, 65b of the protrusion may move down through the one or more front openings of the one or more holder slots 122a, 122b. In this manner, the tool bag 10 is coupled to the ladder top 120 by sliding the cylindrical members 63a, 63b downward into the slots 122a, 122b and uncoupled by lifting the tool bag 10 and sliding the cylindrical members 63a, 63b upward and disengaging them from the slots 122a, 122b.

In some embodiments, each of the one or more holder slots 122a, 122b include a lower ledge 124 disposed on the holder slot forming surface. The ledge 124 may be configured to support the protrusions 64a, 64b of the engagement mechanism 60. When the protrusions 64a, 64b are inserted to and engage with the holder slots 122a, 122b, the cylindrical members 63a, 63b may sit on the ledge 124 so that the cylindrical members 63a, 63b do not advance all the way through the holder slots 122a, 122b.

In some embodiments, the top width of the front opening of the one or more holder slots 122a, 122b may be greater than the bottom width of the front opening of the one or more holder slots 122a, 122b. The wider top width of the front opening of the one or more holder slots 122a, 122b may facilitate aligning the one or more extending, connecting members 65a, 65b with the front opening of the one or more holder slots 122a, 122b when the one or more protrusions 64a, 64b are inserted into the one or more holder slots 122a, 122b. In some embodiments, the width of the front opening of the holder slot is gradually reduced from the top to about the middle, and the lower portion of the front opening of the holder slot may have a consistent width. The lower portion of the front opening may be about half of the front opening or less than half of the front opening (e.g., 40%). In some aspects, the width of the lower portion of the front opening of the one or more holder slots 122a, 122b may match the width of the corresponding extending member 65a, 65, which may allow the engagement member 60 to be securely fixed to the ladder top 120 by preventing the one or more cylindrical member 63a, 63b inserted into the one or more holder slots 122a, 122b from rotating or rotationally moving within the one or more holder slots 122a, 122b. In some embodiments, the upper portion of the edge 126 of the front opening of the one or more holder slots 122a, 122b may be slanted/tapered, and the lower portion of the edge 126 of the front opening of the one or more holder slots 122a, 122b may be vertical.

In some embodiments, the ladder top 120 may have a front surface 134, a rear surface 132, a first side surface 136, a second side surface 138, and a top surface 142. In some embodiments, the front surface 134 of the ladder top 320 may include one or more angled surfaces 135a, 135b. In some embodiments, the first angled surface 135a may be formed between the first holder slot 122a and one edge of the front surface 134 of the ladder top 120 contacting the first side surface 136. The second angled surface 135b may be formed between the second holder slot 122b and the other edge of the front surface 134 of the ladder top 120 contacting the second side surface 138. The angle of the angled surfaces may correspond to the angle of the rails of the front section 112 of the ladder. The one or more ribs 66 of the engagement mechanism 60 may rest against the one or more angled surfaces 135a, 135b of the ladder top 120 when the engagement mechanism 60 is coupled with the one or more holder slots 122a, 122b on the ladder top 120. The front end of the one or more ribs 66 may be in contact with and in alignment with the one or more angled surfaces 135a, 135b of the ladder top 120 when the engagement mechanism 60 is coupled to the one or more holder slots 122a, 122b on the ladder top 120.

In some embodiments, a tool bag includes a container body including one or more woven panels, a bottom rigid member, and a rigid wall hingedly connected to the bottom rigid member, and an engagement mechanism attached to the rigid wall. The engagement mechanism may include a base panel riveted on the rigid wall, and one or more protrusions extending from the base panel. In some aspects, the one or more protrusions are configured to engage with one or more holder slots on a ladder top.

In some embodiments, a collapsible container bag includes a container body including one or more woven panels, a bottom rigid member, and a rigid wall hingedly connected to the bottom rigid member, and an engagement mechanism attached to the rigid wall. In some embodiments, the bottom rigid member includes a bottom plate and a lip extending around a perimeter of the bottom plate. The lip may have a front lip, a rear lip opposite the front lip, a first side lip, and a second side lip opposite the first side lip. The rigid wall may be hingedly connected to the rear lip of the bottom rigid member. The rigid wall may include an interior enhancing panel and a fabric portion encompassing the interior enhancing panel. The one or more woven panels may include a front woven panel hingedly connected to the front lip of the bottom rigid member.

In some embodiments, an organizational system includes a ladder 110 with a ladder top 120 having one or more holder slots and a tool bag removably fixable to the ladder top. The tool bag includes a container body including one or more woven panels, a bottom rigid member, and a rigid wall hingedly connected to the bottom rigid member, and an engagement mechanism attached to the rigid wall. The engagement mechanism may include a base panel riveted on the rigid wall, and one or more protrusions extending from the base panel. In some aspects, the one or more protrusions are configured to engage with one or more holder slots on a ladder top.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A tool bag comprising:
a container body including one or more woven panels, a bottom rigid member, and a rigid wall hingedly connected to the bottom rigid member; and
a base panel riveted on the rigid wall; and
one or more protrusions extending from the base panel, the one or more protrusions being configured to engage with one or more holder slots on a ladder top.

2. The tool bag of claim 1, wherein the one or more protrusions include a cylindrical member and an extending member, the extending member connecting the cylindrical member to the base panel.

3. The tool bag of claim 2, wherein the extending member is narrower than the cylindrical member.

4. The tool bag of claim 1, wherein the one or more protrusions and the base panel are is made of molded copolymer polypropylene.

5. The tool bag of claim 1, further comprising one or more ribs extending from the base panel.

6. The tool bag of claim 5, wherein the one or more ribs are configured to rest against an angled surface of the ladder top.

7. The tool bag of claim 5, wherein an extending length of a top end of the one or more ribs is greater than an extending length of a bottom end of the one or more ribs.

8. The tool bag of claim 5, wherein an extending length of the one or more ribs is continuously reduced from a top end to a bottom end.

9. The tool bag of claim 1, wherein the bottom rigid member is a molded plastic including copolymer polypropylene and polyethylene.

10. A collapsible container bag comprising:
a container body including one or more woven panels, a bottom rigid member, and a rigid wall hingedly connected to the bottom rigid member, wherein the bottom rigid member including a bottom plate and a lip extending around a perimeter of the bottom plate, the lip having a front lip, a rear lip opposite the front lip, a first side lip, and a second side lip opposite the first side lip; and
an engagement mechanism attached to the rigid wall;
wherein the rigid wall is hingedly connected to the rear lip of the bottom rigid member, the rigid wall including an interior securement panel and a fabric portion encompassing the interior securement panel, and
the one or more woven panels include a front woven panel hingedly connected to the front lip of the bottom rigid member.

11. The collapsible container bag of claim 10, the front woven panel is horizontally collapsible.

12. The collapsible container bag of claim 10, wherein the front woven panel includes a guide panel, and the front woven panel configured to collapse along an edge of the guide panel.

13. The collapsible container bag of claim 10 further comprising a fastener configured to bind a top end of the rigid wall and a top end of the front woven panel in a closed configuration.

14. The collapsible container bag of claim 10, wherein the one or more woven panels further includes a second woven panel connected to the first side lip of the bottom rigid member and a third woven panel connected to the second side lip of the bottom rigid member, wherein the second woven panel and the third woven panel are collapsible.

15. The collapsible container bag of claim 10 further comprising a flexible strap attached to the bottom rigid member and the interior securement panel, the flexible strap configured to define a maximum angle between the interior securement panel and the bottom plate of the bottom rigid member.

16. The collapsible container bag of claim 10, the lip has a ridge along an outer surface thereof.

17. The collapsible container bag of claim 10, the rigid wall is hingedly connected to the rear lip of the bottom rigid member via a seam including stitching fixing the rigid wall to the rear lip of the bottom rigid member.

18. An organizational system comprising:
a ladder with a ladder top having one or more holder slots; and
a tool bag removably fixable to the ladder top, the tool bag including:
a container body including one or more woven panels, a bottom rigid member, and a rigid wall hingedly connected to the bottom rigid member,
a base panel riveted on the rigid wall, and
one or more protrusions extending from the base panel, the one or more protrusions configured to engage with the one or more holder slots on the ladder top.

19. The organizational system of claim 18, wherein the rigid wall includes an interior securement panel and a fabric portion encompassing the interior securement panel.

20. The organizational system of claim 18, wherein
the bottom rigid member includes a bottom plate and a lip extending around a perimeter of the bottom plate, the lip having a front lip, a rear lip opposite the front lip, a first side lip, and a second side lip opposite the first side lip;
the rigid wall is hingedly connected to the rear lip of the bottom rigid member; and
the one or more woven panels include a front woven panel hingedly connected to the front lip of the bottom rigid member.
